(19) United States
(12) Patent Application Publication
(10) Pub. No.: US 2010/0186591 A1
(43) Pub. Date: Jul. 29, 2010

(54) SYSTEM AND PROCESS FOR HANDLING A CO2 COMPRISING WASTE GAS AND SEPARATION OF CO2

(75) Inventors: Otto Skovholt, Trondheim (NO); Svein Berg, Trondheim (NO); Geir Johan Rortveit, Ranheim (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: STATOIL ASA, STAVANGER (NO)

(21) Appl. No.: 12/665,258

(22) PCT Filed: Jun. 18, 2008
(86) PCT No.: PCT/NO2008/000223

§ 371 Date: Dec. 17, 2009

(30) Foreign Application Priority Data
Jun. 21, 2007 (NO) 20073181

(51) Int. Cl. B01D 53/14; B01D 19/00

(52) U.S. Cl. 95/183; 96/188

(57) ABSTRACT

A system and method for handling waste gas including separation of CO₂ is disclosed. The system includes a horizontal tunnel with a sequence of sections including a cooling section, a CO₂ absorption section and a cleansing section. The system further comprises a heat exchanger for heating the CO₂ depleted waste gas before it is introduced into the chimney with heat from the incoming untreated waste gas.

The present invention relates to a system and a process for handling a CO₂ comprising waste gas and separation of CO₂.

At present there is a great interest in developing new solutions and enhancing existing technologies for CO₂ capture. This interest is based on the awareness of the environmental effects of the increased concentration of CO₂ in the atmosphere, especially global warming.

One of the conventional approaches to this problem has been to adapt traditional equipment for absorption of other gases to the absorption of carbon dioxide by including carbon dioxide absorbents and adjust the equipment to the new conditions. However, many of the conditions with respect to CO₂ capture are considerable different and give rise to issues which have not been experienced before. Some of these are related to the dimensions and the scale of the equipment, others are related to the conditions such as temperature and pressure.

The problems with the size of these systems are especially visible when plans are made for CO₂ capture facilities in connection with large power plants such as gas powered power plants. The amount of generated exhaust and the capability of the available CO₂ absorbents lead to a demand for very large and tall absorbers or the need for several absorbers run in parallel.

Although a lot of research and development has been going on with respect to CO₂ capture neither large scale testing nor operations have yet been performed to any considerable extent. Therefore there is a great interest and need for a system that can be constructed in a large scale of relatively in-expensive materials and which is flexible so that large scale testing and optimisation, including changing the different parameters, can be performed.

U.S. Pat. No. 5,826,518 describes a combined flue gas heat recovery and pollutants removal system. Removal of CO₂ is not disclosed.

RU 2,091,139 discloses a horizontal absorber with to levels.

EP1707876 A1 discloses a device for absorption of SO₂ from an exhaust gas. The exhaust gas stream has a mainly horizontal flow trough the device. The device further comprises spray nozzles which introduce a washing liquid to the gas stream. The SO₂ absorbent included in the washing liquid is an alkaline earth metal compound.

U.S. Pat. No. 4,343,771 disclose a horizontal gas-liquid contactor for removing sulphur dioxide from a gas stream. Liquid spray nozzles are arranged at the top with a preferred spacing.

CA 2,504,594 describes a “rainstorm tunnel” equipped with spray nozzles for introducing liquid spray to an effluent gas in helical motion within the tunnel. CO₂ separation is disclosed as a possible last step utilising a spray comprising calcium and an enzyme mixture.

SU 1745314 describes removal of CO₂ from natural gas in a horizontal absorber; the absorbent is an aqueous ammonia solution.

WO 00/74816 discloses a combined flue gas desulphurisation and carbon dioxide removal system. In one of the disclosed embodiments the system comprises two horizontal orientated chambers. In one of the chambers a liquid comprising a CO₂ removing reagent is sprayed horizontally and co-currently into the gas stream. The CO₂ removing reagent is an amine. An integration of the system with a power plant is not disclosed.

The object of the present invention is to provide a new concept for construction and operation of a CO₂ capture plant. Further it is an object to provide a flexible plant, where each section is easily accessible, and the set up and configuration of the system can be altered without enormous costs. Another object is it to provide a method of operation applicable for use with low cost construction materials. It is also an object to provide for an effective utilisation of heat sources.

These and other objects are reached by the system and the method disclosed here.

The present invention provides a system for handling a waste gas stream and separating CO₂ there from, characterised in that the system comprises
an inlet for CO₂ comprising waste gas into an essential horizontal tunnel like structure comprising in sequence an CO₂ absorption section and a cleaning section, and a downstream CO₂ lean exhaust gas outlet in fluid communication with a cold gas inlet into a heat exchanger, and
where the heat exchanger further comprises an inlet for hot gas, an outlet for gas with reduced temperature and a heated gas outlet, and
a chimney with an inlet in fluid communication with said heated gas outlet from said heat exchanger.

The present invention further provides a method for handling a waste gas stream and separating CO₂ there from, characterised in that the method comprises
I) —feeding a CO₂ comprising waste gas as an essential horizontal stream into an essential horizontal tunnel like structure, and whilst keeping a mainly horizontal flow performing the following steps:
   Ia) —optionally cooling said gas stream,
   Ib) —bringing the gas stream in contact with a CO₂ absorbent,
   Ic) —absorbing CO₂ from the gas stream obtaining a CO₂ depleted gas stream,
   Id) —cleansing said CO₂ depleted gas stream; thereby obtaining a cold CO₂ depleted waste gas, and
II) —heating said cold CO₂ depleted waste gas by heat exchange with a hot stream.

In one embodiment of the system according to the present invention the horizontal tunnel like structure further comprises a cooling section upstream the absorption section. The need for cooling will depend on the waste gas source and on the selected absorbent.

Other embodiments of the present invention are disclosed in the independent claims.

In one aspect of the present invention the source of the waste gas is a power plant. The power plant may be any type of power plant involving combustion and creation of an exhaust gas comprising CO₂, such as a plant powered by coal, oil or gas.

The term “waste gas” means, within this text, any gas stream comprising CO₂ together with one or more other gas compounds. Waste gas in this context includes exhaust from combustion units such as power plants and engines, waste gas from industrial processes such as, waste gas from steel and aluminium processing, cement furnaces, etc.

The term “horizontal” as applied here is used to define the main direction of a flow or a structure. The term also covers mainly horizontal directions which may comprise parts with a descending and/or ascending angle.

The present invention is not restricted to the use of a specific type of absorbent but can be utilised with any type of absorbent. The absorbent is brought into contact with the waste gas in the form of liquid droplets comprising the absorbent or a packing material wetted by the absorbent. The droplets may further comprise a diluent and/or a solvent, which together with the absorbent form a solution and/or suspension. Examples of applicable absorbents are primary, secondary or tertiary amines such as mono ethanol amine (MEA), and carbonate forming compounds such as a calcium compound a potassium compound, a combination of soda and salt or ammonia. In one aspect of the present invention the preferred absorbent is an aqueous ammonia solution.

The droplets comprising the absorbent can in one aspect of the invention alone represent the contact surface between the solvent and the waste gas. In another aspect of the invention the absorption section further comprises a filling material for enhancing the contact between the gas and the liquid.

The horizontal tunnel like structure of the system according to the present invention provides the possibility to add, remove or alter the different sections without having to rebuild the whole system. Access entrances may be included in every section, and due to the horizontal orientation both researchers, technicians and maintenance staff can access each section without having to climb high towers. Further the horizontal layout of the system reduces the structural support needed as the weight per area is reduced compared to a similar vertical arrangement of the different sections.

In one aspect of the present invention the system may further comprise tunnel sections for removing different other gaseous substances from the waste gas, such as NOₓ and SO₂.

In one aspect of the present invention the tunnel structure can be constructed of concrete which may be coated with a material to provide a more smooth and inactive surface. The use of concrete allows for construction of tunnels with a very large cross-section at relatively low costs compared to an absorption tower with the same dimension constructed in costly steel. The large cross-section makes it possible to keep the velocity of the gas low and provide a low friction loss.

The present invention will be described in further detail with reference to the enclosed figures where:

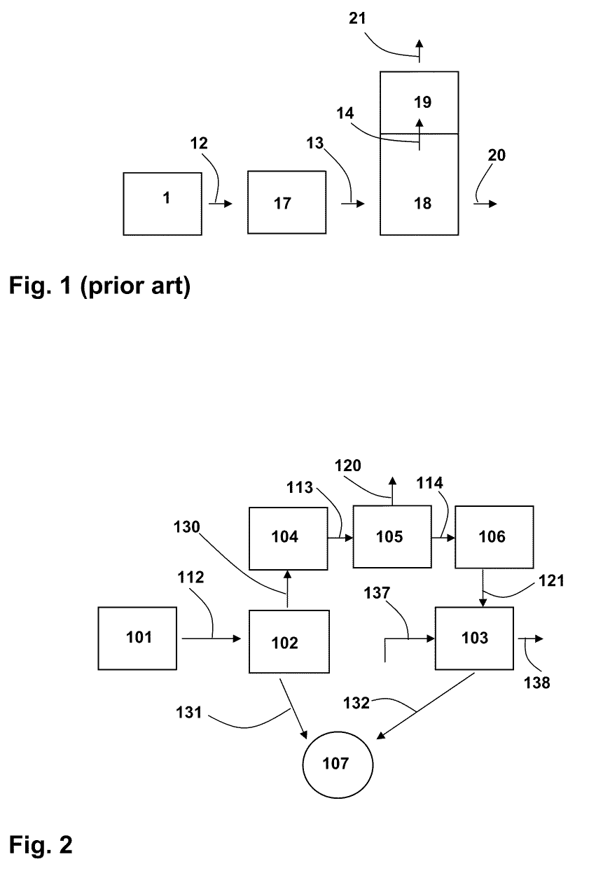

FIG. 1 illustrates a system according to the prior art, from a side view;

FIG. 2 illustrates an embodiment of a system according to the present invention, from a top view;

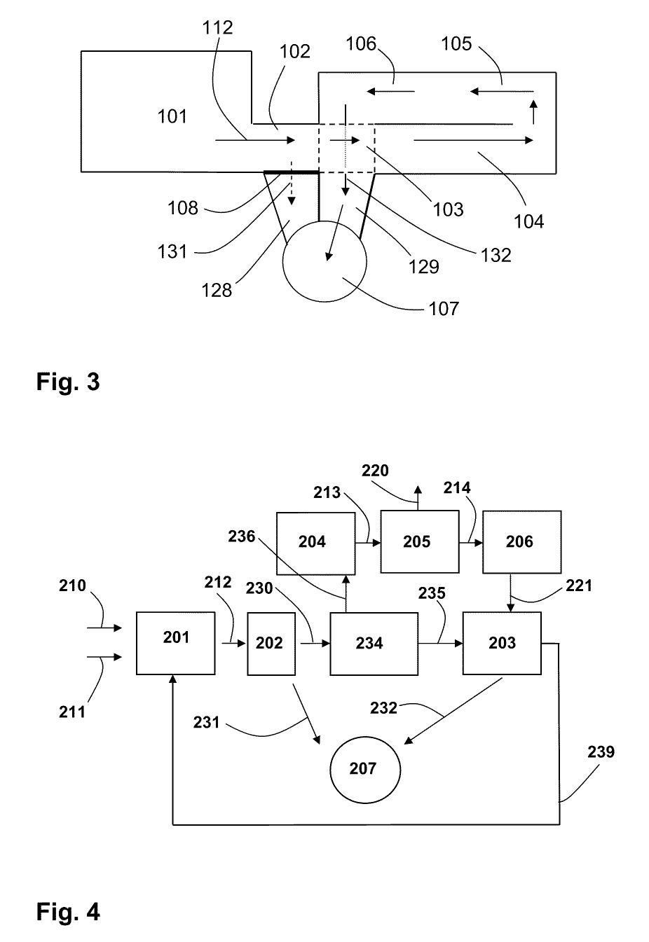

FIG. 3 illustrates an embodiment of the present invention, from a top view;

FIG. 4 illustrates one embodiment of a system according to the present invention; where the waste gas producing unit is a power plant, from a top view;

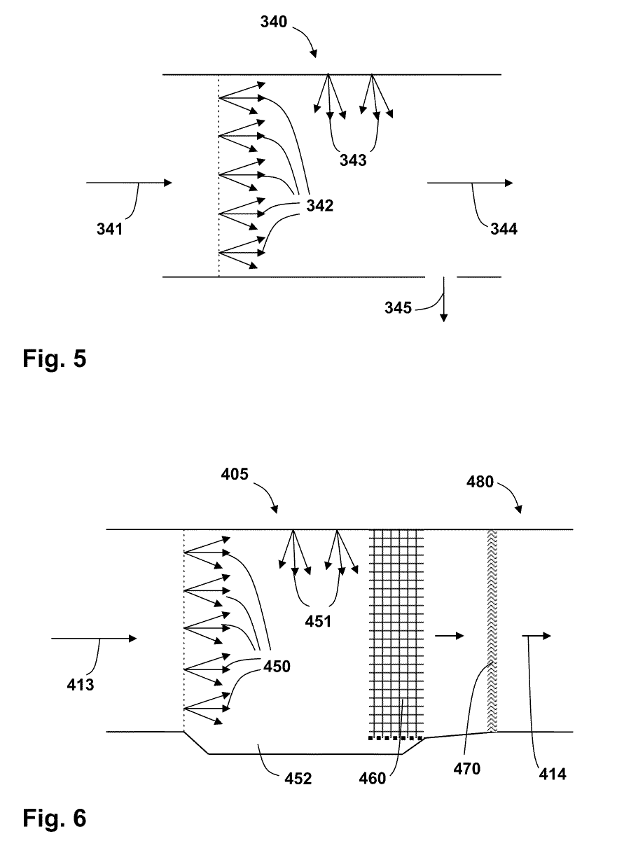

FIG. 5 illustrates a horizontal channel with spray nozzles, from a side view; and

FIG. 6 illustrates an embodiment of a horizontal absorber channel, from a side view.

Wherever applicable, similar reference numbers are used to identify comparable units and/or streams. A list of the reference numbers used in the drawings and a specification thereof is enclosed at the end of the description.

FIG. 1 illustrates a system according to the prior art where a waste gas producing unit 1, like a gas power plant or similar produces a stream of hot waste gas 12 which is introduced to a cooling unit 17. The resulting cooled waste gas 13 is introduced to a vertical absorber 18 where CO₂ is absorbed by an absorbent. The CO₂ rich absorbent leaves the absorber as stream 20. The obtained CO₂ depleted waste gas stream 14 is introduced to a water wash section 19 of the vertical absorber 18 to reduce the content of absorbent in the gas. The water wash results in a stream of CO₂ depleted cleansed waste gas 21. This system is inflexible in the sense that after the absorber is designed and constructed it is limited to the selected height. If a longer path is needed it is very difficult to add an extra section on top of the absorber 18. If a shorter path is needed to optimize the operation of the absorber the entrance point of the absorbent liquid must be lowered or the entrance point of the gas be raised. If such CO₂ capture plant was to be built for large scale testing and optimisation this indicates that one would have to build a higher absorber than the calculations suggest to obtain this flexibility, the price for this flexibility will accordingly be very high.

FIG. 2 illustrates an embodiment of the present invention in a top view perspective. A waste gas producing unit 101 generates a waste gas stream 112. The temperature of this stream may vary depending on the type of unit. The unit may, if applicable, include means for recovering heat from the waste gas up to a certain point. When leaving the unit 101 the waste gas will usually have a temperature within the range of 150-70° C., but the waste gas may even have a temperature below 70° C. The waste gas is introduced to a first section of a horizontal waste gas channel 102 which during normal operation functions as a channel connecting unit 101 with a cooling section 104. The channel comprises a damper or similar which can be opened. The damper provides a possibility to by-pass the capture system and to direct the waste gas stream 131 directly into a chimney 107. This option can be utilized during maintenance and/or start-up of the capture system, when the waste gas producing unit 101 is running continuously and/or during start-up of unit 101.

Having past the channel 102 the waste gas 130 enters the cooling section 104. Depending on the selected absorbent and the origin of the waste gas the temperature of the waste gas may have to be reduced to a temperature adapted to the absorbent and the absorption process. For some amine based absorbents a temperature below 40° C. is sufficient to achieve efficient absorption, whereas some carbonate forming absorbents may need 15° C. or below. Therefore in this embodiment of the invention the waste gas 133 is introduced to a first section 104 of a tunnel like horizontal structure. Within this section 104 the waste gas is cooled to a necessary extent. While the gas flows horizontally through the section 104, water with a temperature below the desired gas temperature is sprayed as droplets into the stream. The water droplets absorb heat from the gas as they fall trough the stream. The water is collected and drained from the bottom of the channel. The cooled waste gas 113 flows horizontally from the cooling section into an absorption section 105 where droplets comprising an absorbent are introduced into the gas stream and allowed to fall through the gas. Hereby the absorbent is brought into contact with the CO₂ which is absorbed thereby. The arrangement of the spray nozzles is described in further detail below. In one embodiment of the invention the droplets are allowed to at least partly follow the horizontal gas stream for a while as they slowly fall to the bottom of the channel. In another embodiment of the present invention the absorption section may comprise a filling material. The droplets will form a liquid film upon the filling material which increases the contact surface between the liquid and the gas phase.

The absorption section may be separated into smaller sub-sections each comprising spray nozzles and means for collecting the absorption fluid at the bottom of the tunnel. In a preferred embodiment CO₂ lean absorbent solution is introduced through the nozzles in the last of the sub-sections, the absorption fluid collected at the bottom thereof is pumped back into the tunnel through the spray nozzles in the previous sub-section and so forth; whereby a type of cross-current flow is obtained.

The CO₂ rich absorption fluid leaves the tunnel structure as stream 120 and enters into a desorption system, not shown. The obtained CO₂ depleted waste gas 114 flows horizontally into the next section 106 of the tunnel like structure, where the waste gas is washed with water and/or cleansed by other means. The cleansing procedure will depend on the source of the gas, the absorbent used and the restrictions regarding release of waste gas. When utilizing an amine based absorbent on the exhaust from a natural gas power plant, a water wash may be enough, whereas if a basic absorbent such as ammonia is used an acid cleansing may have to be included to remove ammonia present in the gas phase. This cleansing is performed similar to the cooling and the absorption by spraying the cleansing medium through nozzles into the horizontal steam, letting the droplets fall through the gas and collect the medium at the bottom of the tunnel and drain it from there. The cleansing process may also in other embodiments of the invention involve removing other substances from the waste gas such as NOₓ and/or SO₂. The cleansed CO₂ depleted waste gas stream 121 will have a temperature which is within the range of the temperature of the cooled waste gas stream 113 approximately less than 40° C. If this gas was to be released directly via the chimney fans would have to be installed to pull and/or push the gas up through the chimney. However the CO₂ depleted waste gas stream 121 is past trough a heat exchanger 103 thereby obtaining a heated CO₂ depleted waste gas stream 132. Thereby the temperature of the depleted waste gas 132, which is introduced into the chimney, is increased. If the temperature is increased to approximately 70° C. this will create a current or draft in the chimney strong enough to limit any fan work considerably and in an advantageous embodiment eliminates the need for any fan work. In an even more advantageous embodiment the pressure that the waste gas producing unit must overcome may be reduced, whereby its efficiency may be increased. The increase in temperature further ensures that the possible oxygen lean CO₂ depleted waste gas rises after leaving the chimney without creating areas with oxygen lean air near the ground. By heating the waste gas the relative humidity is reduced and the visibility of the steam coming out of the chimney is thereby reduced. A hot stream 137 provides the heat in the heat exchanger 103 and leaves the heat exchanger as cooled stream 138. This hot stream 137 may be any available stream comprising enough heat to rise the temperature of the stream 121.

In one embodiment of the present invention the hot stream into the heat exchanger may be equal to the waste gas stream 130 and the thereby obtained partly cooled waste gas stream is directed into the cooling section 104 for further cooling. In this embodiment the depleted gas 121 is heated in the heat exchanger 103 with the heat from the waste gas, which would otherwise have been considered waste heat. In this embodiment the heat exchanger 103 forms a part of the horizontal channel which thereby forms a loop like circuit.

FIG. 3 illustrates the continuous loop like gas flow according to one embodiment of the present invention. The system comprises the same sections than the system shown on FIG. 2. The arrows indicate the gas flow through the system. In the sections 104, 105 and 106 the gas flow is mainly horizontally, however to form a loop the system must comprise one or more curved sections, as shown. The damper 108 illustrates the possibility to by-pass the absorption system. In the heat exchanger 103 heat is transferred from the waste gas to a CO₂ depleted and cleansed waste gas stream 121. Thereby a partly cooled waste gas stream 133 is obtained.

FIG. 4 illustrates an embodiment of the present invention where the waste gas producing unit is a gas turbine power plant 201 design and operated with recycling of exhaust gas. Here fuel 210 in the form of gas and air 211 are feed to the power plant 201. Energy from the combustion is extracted from the exhaust via conventional turbine(s) and heat recovery systems before the exhaust enters as stream 212 into the channel 202 and further as stream 230 into a splitter 234. In this aspect of the invention the waste gas is split into a recycle stream 235 and a rest stream of exhaust 236 which is introduced to the CO₂ capture system comprising a sequence of horizontal sections 204, 205, 206 similar to the sections 104, 105 and 106 on FIG. 2. In every aspect of the invention the dimension and the construction for each unit will be adapted to the actual waste gas source to ensure low gas velocity. The recycle stream 235 is cooled in the heat exchanger 203 and thereby heat is supplied to the CO₂ depleted rinsed waste gas stream 221. The cooled recycle stream 239 may be cooled further or treated in other ways before and/or after it enters the power plant. In the illustrated embodiment the recycle stream 235 contains enough heat to result in the desired temperature increase in the heated CO₂ depleted stream 232 before it enters the chimney 207.

To separate CO₂ from the absorbent the CO₂ rich absorbent stream 20, 120 or 220, is introduced to a stripping and/or desorption system, not shown. The CO₂ lean absorbent can be recycled to the absorption section. The construction and the design of this unit will depend on the choice of absorbent and diluent system. If the absorbent is an amine compound it may be possible to utilise waste heat from the waste gas producing unit 1, 101 or 201 to heat the CO₂ rich absorbent stream and facilitate the desorption of CO₂. If the absorbent is a carbonate forming compound the CO₂ rich absorbent stream 20, 120 or 220 may comprise the carbonates in dissolved form or in the form of solid particles and the desorption system will have to be adapted to these different situations. The desorption process may be performed according to known techniques.

In one aspect of the present invention the cooling in section 104 and 204 is performed by direct water cooling, by spraying water into the waste gas stream. The water may come from a natural water source such as the sea, a lake or a river and the water may be returned to said natural source. However in another aspect the water is cooled and recycled in a more or less closed loop. In yet another aspect the cooling in section 104 and 204 is performed as indirect cooling with a cooling medium via a gas tight barrier.

Liquid may be sprayed into many of the different sections of a tunnel according to the present invention. The spraying of the liquid and formation of droplets is performed via spray nozzles arranged within the different tunnel sections. The liquid spray nozzles may be arranged on any side of the tunnel wall, or within the tunnel and the nozzles may direct the droplets in any direction. The droplets may accordingly have a counter-current, co-current, orthogonal direction compared to the horizontal gas flow or any combination thereof. FIG. 5 illustrates an advantages arrangement of nozzles within a tunnel, according to one aspect of the present invention. The advantage of this arrangement is that the whole cross section of the tunnel is exposed to the droplets. Here a gas stream 341 flows horizontally into a section 340 were droplets of liquid are sprayed out both horizontally via nozzles 342 and from the ceiling via nozzles 343. The liquid droplets fall down through the gas flow due to gravity and are collected and drained as a stream 345. The nozzles are selected to provide droplets of a size adapted to the velocity of the gas flow so as to allow for the droplets to follow the gas stream for a while before settling at the bottom of the tunnel; this secures a long retention time and thereby allowing the CO₂ to react with the absorbent. The treated gas phase continues horizontally as stream 344. The illustrated section can according to different embodiments of the present invention illustrated any one of the tunnel sections for cooling, absorption and cleansing. The liquid introduced through the nozzles 342 and 343 depends directly on which type of section which is illustrated.

FIG. 6 illustrates an absorption section or sub-section 405. Cooled waste gas 413 flows horizontally into the section and is brought into contact with an absorption fluid in the form of droplets sprayed out through nozzles 450 and 451. The fluid droplets comprising absorbed CO₂ are collected at the bottom of the tunnel in a reservoir 452. The reservoir prolongs the retention time which may provide further enhanced absorption depending on the kinetics of reaction(s) with the selected absorbent. The increased retention time may be obtained as shown by including a reservoir with in the this section of the channel or by retaining the absorbent fluid 120 or 220 (on FIGS. 2 and 4, respectively) in a container and/or tank for a selected period of time before transferring the matured absorbent fluid to a downstream desorption system. In one aspect of the invention, after having been sprayed with droplets comprising an absorbent the gas and the droplets flow horizontally and collides with a fill and/or packing material 460. The fill material may be any type of fill material where upon the droplets can form a liquid film and thereby form a contact surface with the gas and enhances the contact time. To remove liquid droplets and keep them from being transported with the gas into the next section the gas passes a demister 470 before leaving this section as gas stream 414. The demister 470 collects the drops and directs the liquid to the reservoir 452. The gas continues horizontally from there as CO₂ depleted gas stream 414 in a connection channel 480. The demister 470 is not restricted to any special construction, examples of applicable demisters are wire mesh demister, fill materials and similar.

The system according to the present invention may comprise demisters after each of the sections for cooling, absorption and cleansing or even within these sections to minimize the amount of liquid transferred by the gas onto the following section.

The geometry of the tunnel according to the present invention is not restricted and the cross-section of the tunnel may be any shape such as square, rectangular, oval or circular. The system according to the present invention with the horizontal tunnel like structure provides the possibility to build units with a large cross-section which again provides for relatively low gas velocities. The velocity of the waste gas in the tunnel may be from 1 to 10 m/s, preferably from 2-7 m/s, advantageously from 1 to 6 m/s, more advantageously from 2 to 5 m/s. As illustrated on FIG. 2-4 the tunnel like structure may comprise bends or be curved.

In one aspect of the present invention gates or doors are arranged along the tunnel structure to allow for access to the equipment for maintenance and reconfiguration purposes. Due to the horizontal configuration every part of the tunnel is easy accessible.

In yet another aspect of the present invention the system can be adapted to absorb other compounds such as sulphur oxide, by introducing or reconfiguring section or a part of a section to introduce a sulphur oxide absorbent into the waste gas stream.

In one embodiment of the present invention the chimney is further at the top thereof equipped with a bend pipe connected to the chimney opening via a rotary connection. The aim of this extension pipe is to make use of the suggestion effect created by the speed of the wind, which is dominant climate in many locations in particular in coastal areas. This suggestion effect is added to the above described thermal chimney effect and thereby enhances the draught. The rotary connection secures that the direction of the bend pipe is adaptable to the direction of the wind.

### REFERENCE NUMBERS

1, 101, 201 Waste gas producing unit
102, 202 Horizontal waste gas channel
103, 203 Heat exchanger
104, 204 Section of horizontal channel used for cooling
105, 205, 405 Section of horizontal channel used for absorption
106, 206 Section of horizontal channel for water wash and/or other cleansing
107, 207 Chimney for CO₂ depleted waste gas
108 Bypass damper
210 Fuel
211 Air
12, 112, 212 Hot waste gas
13, 113, 213, 413 Cooled waste gas
14, 114, 214, 414 CO₂ depleted waste gas
17 Cooling unit
18 Vertical absorber
19 Water wash section of the vertical absorber
20, 120, 220 CO₂ rich absorbent
21, 121, 221 CO₂ depleted rinsed waste gas
128 Bypass channel
129 Connection channel to chimney
130, 230 Main stream of waste gas
131, 231 Bypass of non-CO₂ depleted waste gas
132, 232 Heated CO₂ depleted waste gas
234 Splitter
235 Waste gas recycle stream
236 Waste gas
137 Hot stream
138 Cooled stream
239 Cooled recycle stream
340 Channel section for gas liquid interaction
341 Gas stream
342 Horizontal, co-current liquid spray nozzles
343 Vertical, liquid spray nozzles
344 Gas stream after exposure to drops of liquid
345 Liquid drain
450 Horizontal, co-current absorption liquid spray nozzles
451 Vertical, absorption liquid spray nozzles
452 Liquid collection pool
460 Packing material
470 Demister
480 Connection channel

1. A system for handling a waste gas stream and separating CO₂ there from, the system comprising:
an inlet for CO₂ comprising waste gas into an essentially horizontal tunnel like structure comprising in sequence an CO₂ absorption section and a cleaning section, and a downstream CO₂ lean exhaust gas outlet in fluid communication with a cold gas inlet into a heat exchanger, and
where the heat exchanger further comprises an inlet for hot gas, an outlet for gas with reduced temperature and a heated gas outlet, and
a chimney with an inlet in fluid communication with said heated gas outlet from said heat exchanger.

2. The system according to claim 1, wherein the horizontal tunnel like structure upstream the absorption section further comprises a cooling section.

3. The system according to claim 1, wherein the system has a loop like circuit where the inlet for hot gas is in fluid communication with a waste gas outlet from a waste gas producing unit and the outlet for gas with reduced temperature is in fluid communication with the inlet for CO₂ comprising waste gas.

4. The system according to claim 1, wherein the system is installed in connection with a power plant.

5. The system according to claim 4, wherein the system further comprises a splitter arranged in the waste gas stream upstream of the heat exchanger and a waste gas recycle conduit connected to the power plant.

6. The system according to claim 1, wherein the system further comprises a damper for by-passing the tunnel like structure.

7. The system according to any claim 2, wherein at least one of the cooling section, the CO₂ absorption section and/or the cleaning section comprises spray nozzles for introducing liquid droplets into the waste gas stream.

8. The system according to claim 7, wherein the spray nozzles are arranged in the top part and in a cross section of the tunnel for directing the droplets vertically downwards and co-currently with the gas stream.

9. The system according to claim 7, wherein the absorption section further comprises a packing material.

10. The system according to claim 1, wherein the CO₂ absorption section comprises spray nozzles for introducing liquid droplets and that the system further comprises a reservoir and/or container for absorption fluid for prolonging the retention time.

11. A method for handling a waste gas stream and separating CO₂ there from, the method comprising:
I) —feeding a CO₂ comprising waste gas as an essential horizontal stream into an essential horizontal tunnel like structure, and whilst keeping a mainly horizontal flow performing the following steps:
Ia) —optionally cooling said gas stream,
Ib) —bringing the gas stream in contact with a CO₂ absorbent,
Ic) —absorbing CO₂ from the gas stream obtaining a CO₂ depleted gas stream,
Id) —cleansing said CO₂ depleted gas stream; thereby obtaining a cold CO₂ depleted waste gas, and
II)—heating said cold CO₂ depleted waste gas by heat exchange with a hot stream.

12. The method according to claim 11, wherein at least a part of said hot stream is equal to said CO₂ comprising waste gas which is pre-cooled in step II) before it is fed according to step I).

13. The method according to claim 11, wherein the cooling in step Ia) is obtained by direct cooling with a liquid.

14. The method according to claim 11, wherein the cleaning in step Id) is obtained by spraying one or more liquids in the form of droplets into the gas stream.

15. The method according to claim 11, wherein step Ic) comprises spraying droplets of a liquid comprising a CO₂ absorbent into the gas stream.

16. The method according to claim 15, wherein fluid is collected at the bottom of the tunnel like structure and removed for separate desorption of CO₂ therefrom.

17. The method according to claim 16, wherein the collected fluid is given a prolonged retention time before CO₂ is desorbed therefrom.

18. The method according to claim 11, wherein the contact between the gas and the liquid is enhanced in at least one of the steps Ia)-Id) by allowing the droplets to wet a packing material and form a contact surface thereon.

19. The method according to claim 11, the method further comprises splitting of the waste gas stream and recycling a first part thereof to a power plant after having heated a cold CO₂ depleted waste gas stream by heat exchange according to step II) and feeding the second part thereof as a horizontal stream according to step I).
